(19) United States
(12) Patent Application Publication
(10) Pub. No.: US 2025/0145471 A1
(43) Pub. Date: May 8, 2025

(54) CARBON PROCESSING FOR ENERGY STORAGE SYSTEMS

(71) Applicant: CAPYBARA ENERGY LLC, Seabrook, NH (US)

(72) Inventors: Matthew Millard, Seabrook, NH (US); Daniel Danila, Sharon, MA (US)

(21) Appl. No.: 18/936,857

(22) Filed: Nov. 4, 2024

Related U.S. Application Data
(60) Provisional application No. 63/546,930, filed on Nov. 2, 2023.

(51) Int. Cl. C01B 32/324; H01G 11/34; H01G 11/86

(52) U.S. Cl. CPC C01B 32/324; H01G 11/34; C01P 2006/40; H01G 11/86

(57) ABSTRACT

Disclosed herein is a method of processing carbonaceous material that includes combining a first stream of a first carbonaceous material and a second stream of a second carbonaceous material into a combined stream of carbonaceous material. A parameter of the first carbonaceous material has a first value and the parameter of the second carbonaceous material has a second value that is different than the first value. The method also includes removing only a portion of an impurity, a contaminant, or a combination of the impurity and the contaminant from the combined stream of carbonaceous material. The method further includes carbonizing the combined stream of carbonaceous material by exposing the combined stream of carbonaceous material to energy in the form at least one of: heat, electricity, microwave radiation, or light. The method additionally includes converting the combined stream of carbonaceous material into activated carbon.

### CROSS-REFERENCE TO RELATED APPLICATION

This application claims the benefit of U.S. Provisional Patent Application No. 63/546,930, filed Nov. 2, 2023, which is incorporated herein by reference in its entirety.

### FIELD

This disclosure relates generally to processing carbonaceous material, and more particularly to carbon processing for energy storage systems.

### BACKGROUND

Carbon materials can be used in various applications, such as energy storage systems, water treatment, and environmental remediation. Carbon processing can help to make materials including carbon suitable for such applications. Activated carbon can help with absorption, filter impurities from water and/or air, and serve as a support for catalysts.

### SUMMARY

The subject matter of the present application has been developed in response to the present state of the art, and in particular, in response to the shortcomings of processing of carbonaceous material, such as those described below, that have not yet been fully solved by currently available techniques. Accordingly, the subject matter of the present application has been developed to provide carbon processing for large format supercapacitors that overcome at least some of the shortcomings of prior art techniques.

The following is a non-exhaustive list of examples, which may or may not be claimed, of the subject matter, disclosed herein.

Disclosed herein is a method of processing carbonaceous material. The method includes combining a first stream of a first carbonaceous material and a second stream of a second carbonaceous material into a combined stream of carbonaceous material. A parameter of the first carbonaceous material has a first value and the parameter of the second carbonaceous material has a second value that is different than the first value. The method also includes removing only a portion of an impurity, a contaminant, or a combination of the impurity and the contaminant from the combined stream of carbonaceous material. The method further includes carbonizing the combined stream of carbonaceous material by exposing the combined stream of carbonaceous material to energy in the form at least one of: heat, electricity, microwave radiation, or light. The method additionally includes converting the combined stream of carbonaceous material into activated carbon. The preceding subject matter of this paragraph characterizes example 1 of the present disclosure.

The combined stream of carbonaceous material is converted into the activated carbon concurrently with the combined stream of carbonaceous material being carbonized. The preceding subject matter of this paragraph characterizes example 2 of the present disclosure, wherein example 2 also includes the subject matter according to example 1, above.

The parameter includes a carbon content and the first value includes a carbon content different from a carbon content of the second value. The preceding subject matter of this paragraph characterizes example 3 of the present disclosure, wherein example 3 also includes the subject matter according to any of examples 1-2, above.

The parameter includes a cellulose content and the first value comprises a cellulose content different from a cellulose content of the second value. The preceding subject matter of this paragraph characterizes example 4 of the present disclosure, wherein example 4 also includes the subject matter according to any of examples 1-3, above.

The activated carbon has a carbon content not greater than 90 percent. The preceding subject matter of this paragraph characterizes example 5 of the present disclosure, wherein example 5 also includes the subject matter according to any of examples 1-4, above.

The method further includes mixing the combined stream of carbonaceous material with water to form a mixture. Carbonizing the combined stream of carbonaceous material includes exposing the mixture to the energy. The preceding subject matter of this paragraph characterizes example 6 of the present disclosure, wherein example 6 also includes the subject matter according to any of examples 1-5, above.

Carbonizing the combined stream of carbonaceous material includes performing a primary carbonization process. Converting the combined stream of carbonaceous material into activated carbon includes performing a primary activation process, the primary activation process includes converting the mixture into an activated mixture of water and activated carbon. The method further includes separating the activated carbon from the activated mixture to create separated carbon, performing a secondary carbonization process on the separated carbon, and activating the separated carbon in a secondary activation process. The preceding subject matter of this paragraph characterizes example 7 of the present disclosure, wherein example 7 also includes the subject matter according to example 6, above.

The method further includes, prior to performing the secondary carbonization process, pelletizing the separated carbon to create pelletized activated carbon. The secondary carbonization process is performed on the pelletized activated carbon. The preceding subject matter of this paragraph characterizes example 8 of the present disclosure, wherein example 8 also includes the subject matter according to example 7, above.

At least one of the first carbonaceous material and the second carbonaceous material includes plastic waste, agricultural residue, food waste, human waste, industrial waste, coal, or any combination thereof. The preceding subject matter of this paragraph characterizes example 9 of the present disclosure, wherein example 9 also includes the subject matter according to any of examples 1-8, above.

The method further includes forming the activated carbon into an electrode. The preceding subject matter of this paragraph characterizes example 10 of the present disclosure, wherein example 10 also includes the subject matter according to any of examples 1-9, above.

The electrode includes an electrode of a plurality of discrete electrodes and the method further includes forming the activated carbon into the plurality of discrete electrodes, forming a plurality of cells of an energy storage system, each cell of the plurality of cells including an electrode of the plurality of discrete electrodes, and electrically connecting the plurality of cells in a series connection. The preceding subject matter of this paragraph characterizes example 11 of the present disclosure, wherein example 11 also includes the subject matter according to example 10, above.

Further disclosed herein is a grid-scale energy storage system including a supercapacitor including a cell. The cell includes a first electrode made of activated carbon, a second electrode made of activated carbon, a separator disposed between the first electrode and the second electrode, and an electrolyte solution. The preceding subject matter of this paragraph characterizes example 12 of the present disclosure.

The activated carbon includes carbon activated via the process of combining a first stream of a first carbonaceous material and a second stream of a second carbonaceous material into a combined stream of carbonaceous material. A parameter of the first carbonaceous material has a first value and the parameter of the second carbonaceous material has a second value that is different than the first value. The process also includes removing only a portion of an impurity, a contaminant, or a combination of the impurity and the contaminant from the combined stream of carbonaceous material. The process further includes carbonizing the combined stream of carbonaceous material by exposing the combined stream of carbonaceous material to energy in the form at least one of: heat, electricity, microwave radiation, or light. The process also includes converting the combined stream of carbonaceous material into activated carbon. The preceding subject matter of this paragraph characterizes example 13 of the present disclosure, wherein example 13 also includes the subject matter according to example 12, above.

The supercapacitor is configured to store energy at a rate of greater than or equal to 1 kilowatt (kW) and the electrolyte solution includes an aqueous electrolyte solution. The preceding subject matter of this paragraph characterizes example 14 of the present disclosure, wherein example 14 also includes the subject matter according to any of examples 12-13, above.

Additionally disclosed herein is a system for processing carbonaceous material. The system includes a combination unit configured to combine a first stream of a first carbonaceous material and a second stream of a second carbonaceous material into a combined stream of carbonaceous material. A parameter of the first carbonaceous material has a first value and the parameter of the second carbonaceous material has a second value that is different than the first value. The system also includes a purification unit configured to remove only a portion of an impurity, a contaminant, or a combination of the impurity and the contaminant from the combined stream of carbonaceous material. The system further includes an energy emitter configured to carbonize the combined stream of carbonaceous material by exposing the combined stream of carbonaceous material to energy in the form at least one of: heat, electricity, microwave radiation, or light. The system additionally includes an activation unit configured to convert the combined stream of carbonaceous material into activated carbon. The preceding subject matter of this paragraph characterizes example 15 of the present disclosure.

The system further includes a container that includes an inlet and an outlet, and a pump configured to move the combined stream of carbonaceous material into the container via the inlet, through the container, and out of the outlet. The energy emitter is located to carbonize the combined stream of carbonaceous material while the combined stream of carbonaceous material is within the container. The activation unit is located to convert the combined stream of carbonaceous material into the activated carbon while the combined stream of carbonaceous material is within the container. The preceding subject matter of this paragraph characterizes example 16 of the present disclosure, wherein example 16 also includes the subject matter according to example 15, above.

The system further includes a first conveyor belt, a second conveyor belt located adjacent to the first conveyor belt, a first plate interposed between the first conveyor belt and the second conveyor belt, and a second plate interposed between the first plate and the second conveyor belt. The preceding subject matter of this paragraph characterizes example 17 of the present disclosure, wherein example 17 also includes the subject matter according to any of examples 15-16, above.

The first conveyor belt and the second conveyor belt are configured to, when the combined stream of carbonaceous material is received between the first plate and the second plate, move the first plate, the second plate, and the combined stream of carbonaceous material in a direction. The energy emitter is located to carbonize the carbonaceous material while the combined stream of carbonaceous material is moved in the direction. The activation unit is located to convert the combined stream of carbonaceous material into the activated carbon while the combined stream of carbonaceous material is moved in the direction. The preceding subject matter of this paragraph characterizes example 18 of the present disclosure, wherein example 18 also includes the subject matter according to example 17, above.

The system further includes a press that includes a plurality of plates and configured to receive the combined stream of carbonaceous material between at least two plates of the plurality of plates and apply pressure to the combined stream of carbonaceous material while the carbonaceous material is being carbonized by the energy emitter. The preceding subject matter of this paragraph characterizes example 19 of the present disclosure, wherein example 19 also includes the subject matter according to any of examples 15-18, above.

The system further includes a renewable energy source configured to supply the energy to the energy emitter. The preceding subject matter of this paragraph characterizes example 20 of the present disclosure, wherein example 20 also includes the subject matter according to any of examples 15-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic diagram illustrating an energy storage system, according to one or more examples of the present disclosure;

FIG. 2A is a schematic diagram illustrating a system for processing carbonaceous material, according to one or more examples of the present disclosure;

FIG. 2B is a schematic diagram illustrating a system for processing carbonaceous material that includes a combination unit, according to one or more examples of the present disclosure;

FIG. 2C is a schematic diagram illustrating a system for processing carbonaceous material that includes a purification unit, according to one or more examples of the present disclosure;

FIG. 2D is a schematic diagram illustrating a system for processing carbonaceous material that includes an energy emitter, according to one or more examples of the present disclosure;

FIG. 2E is a schematic diagram illustrating a system for processing carbonaceous material that includes an activation unit, according to one or more examples of the present disclosure;

FIG. 3 is a schematic diagram illustrating a system for processing carbonaceous material that includes a container through which the carbonaceous material moves, according to one or more examples of the present disclosure;

FIG. 4A is a schematic diagram illustrating a system for processing carbonaceous material performing a step of carbonizing the carbonaceous material, according to one or more examples of the present disclosure;

FIG. 4B is a schematic diagram illustrating a system for processing carbonaceous material performing a step of activating the carbonaceous material, according to one or more examples of the present disclosure;

FIG. 5 is a schematic diagram illustrating a system for processing carbonaceous material in batches, according to one or more examples of the present disclosure;

FIG. 6 is a schematic flow chart of a method of processing carbonaceous material, according to one or more examples of the present disclosure; and

FIG. 7 is a schematic flow chart of another method of processing carbonaceous material, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Carbon can help to address some environmental challenges associated with sourcing materials for energy storage systems, such as large-scale supercapacitors. For example, supercapacitors can use substantial quantities of active material, often exceeding 1 ton, that is highly porous and highly conductive. Activated carbon, a material with high surface area and electrical conductivity, can be used for such applications. At large scales, the sourcing of materials or precursors presents significant environmental challenges. Utilizing activated carbon can help to alleviate some of the environmental impacts associated with mining battery materials.

Examples of the present disclosure include methods and systems for processing carbonaceous material that help to: reduce supply chain constraints, facilitate widescale adoption, improve efficiency of handling variation in the quality and form of carbon present in carbonaceous material, and improve cost effectiveness, sustainability, and suitability for use in large-scale supercapacitors.

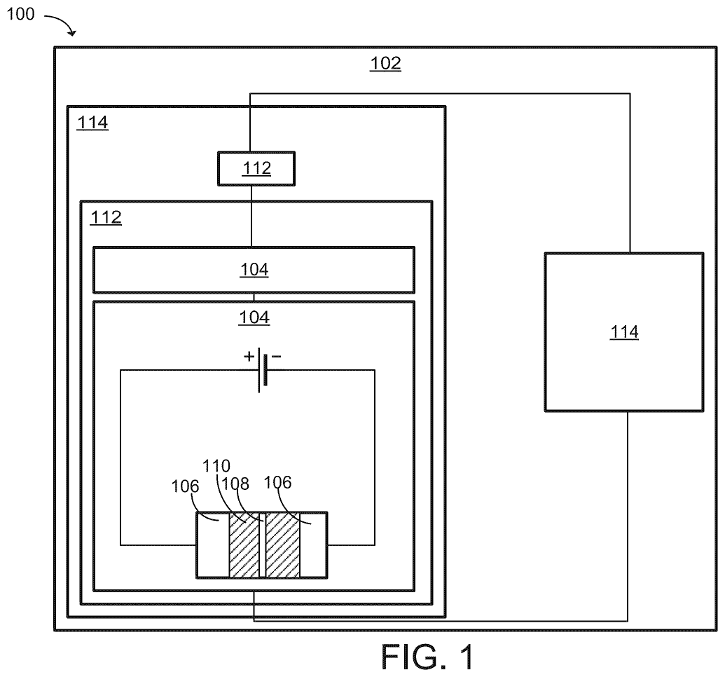

Referring to FIG. 1, examples of the present disclosure include an energy storage system 100. In some examples, the energy storage system 100 includes a supercapacitor 102, such as a large format supercapacitor. In some examples, supercapacitor 102 is configured for long-duration and/or large-scale energy storage. In some examples, the supercapacitor 102 is configured to store energy for periods of greater than or equal to one hour. In some examples, the supercapacitor 102 is configured to store 1 kilowatt-hour (“kWh”) of energy or more. In some examples, the supercapacitor 102 is configured to store energy at a rate of 1 kilowatt (“kW”) or more. In some examples, the supercapacitor 102 is configured to store 1 megawatt-hour (“MWh”) of energy or more.

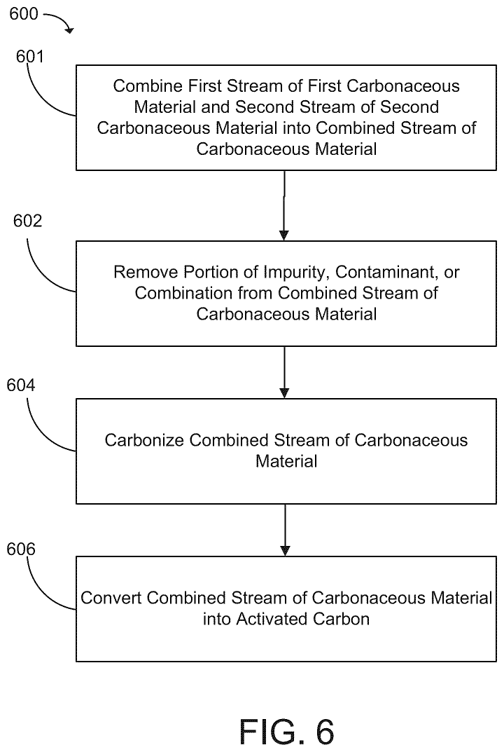

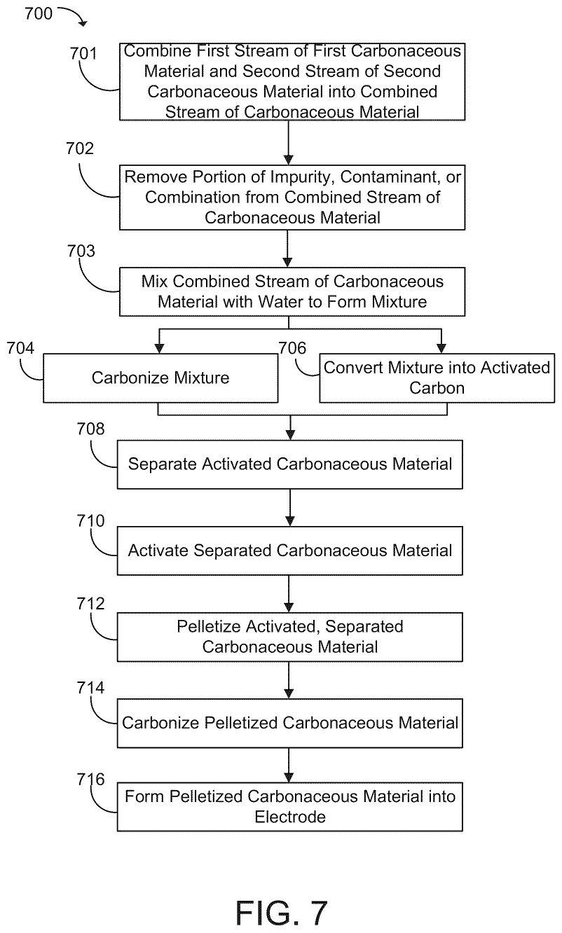

In some examples, the energy storage system 100 is a grid-scale energy storage system. In some examples, the supercapacitor 102 includes cells 104. In some examples, each cell 104 includes at least two electrodes 106 made of activated carbon. Examples of the present disclosure include methods (e.g., methods 600 and 700 illustrated in FIGS. 6 and 7) that output materials suitable for use in the electrodes 106, such as activated carbon. In some examples, the electrodes 106 are made of a non-metallic, porous material, such as carbon that is processed and activated via methods described herein.

In some examples, the electrodes 106 are primarily made of activated carbon, characterized by its high surface area and electrical conductivity. In some examples, this activated carbon encompasses forms such as, but not limited to, graphene, carbon nanotubes, and/or any combination thereof. In some examples, the activated carbon is further functionalized to enhance specific properties that help to facilitate large-scale energy storage, as described herein.

In some examples, the electrodes 106 are discrete from each other. In some examples, the energy storage system 100 includes gaskets or other components to fluidically seal the electrodes 106 from other portions of the energy storage system 100. In some examples, a pair of electrodes 106 in a cell 104 includes a negative electrode and a positive electrode. In some examples, the electrodes 106 are arranged in a bipolar plate configuration. In one or more examples, each electrode 106 is located on and/or faces an opposite surface of a current collector.

In some examples, the cell 104 includes an electrolyte solution 110. In some examples, the electrolyte solution 110 is an aqueous electrolyte solution. In various examples, the electrolyte solution 110 provides ions that migrate from one side of the separator 108 to the other during charging and/or discharging of the cell 104. In some examples, the electrolyte solution 110 includes a liquid. In one or more examples, the electrolyte solution 110 includes a solid substance.

In some examples, the electrolyte solution 110 helps to improve electrical conductivity or influence pH. The electrolyte solution 110 may include alkaline or alkaline earth metal cations, such as, without limitation, Na+, K+, Ca2+, Mg+2, Zn1+, Zn2+, or other first row transition metal. Corresponding anions may include sulfates, phosphates, carbonates, hydroxides, sulfoxides, phosphorous oxides, metal oxides, nitrates, or chlorates. Example electrolyte solutions 110 may include sodium hydroxide, potassium hydroxide, magnesium hydroxide, calcium hydroxide, sodium bicarbonate, sodium carbonate, sodium sulfate, zinc sulfate, and other anions. The electrolyte solution 110 may include additive(s) that may be a mixture of two or several substances. The additive may serve the purpose of lowering the freezing point of the solution. In some examples, the cell 104 is resistant to freezing by having a lower freezing point, by way of accommodating volume changes that occur during freezing, or by draining the electrolyte solution 110 when the cell 104 is stored in colder temperatures.

In some examples, the cell 104 includes a separator 108 interposed between the two electrodes 106. In some examples, the separator 108 is a membrane. In one or more examples, the cell 104 includes a pair of separators 108 located on either side of a current collector. The separator 108, in some examples, is a porous material, homogeneous or composite, non-conductive, that allows the ions of the electrolyte solution 110 to pass through while helping to prevent electrical contact between the electrodes 106. The separator 108, in some examples, is hygroscopic, holding the electrolyte solution 110 within its structure. In some examples, the separator 108 is made of at least one of a polymeric material, a ceramic material, plastic, cellulose, paper, leather, cloth, or glass. The separator 108 can be woven or unwoven. The separator 108 is flexible in some examples and semi-rigid in some examples. In various examples, the separator resists both basic or acidic environments with certain embodiments having a desired neutral pH, alkaline pH, or acidic pH. In some examples, the separator 108 is made of a material of sufficient strength to withstand a clamping pressure of the cell 104, helping to avoid punctures and electrical shorts.

Referring to FIG. 1, in some examples, multiple cells 104 of the supercapacitor 102 are electrically connected to each other. In some examples, cells 104 are connected in a series connection to form a group of cells, or a stack 112. In some examples, stacks 112 are connected in a series connection to form a group of stacks 112, or a string 114. In some examples, strings 114 are connected in a parallel connection to form a group of strings 114, or a module of the supercapacitor 102.

Although not shown in FIG. 1, in some examples, the energy storage system 100 additionally includes a processor, such as a processor of an energy management system (“EMS”). In some examples, the processor is configured control current distribution throughout the supercapacitor 102 via a connection with a distribution component. In various examples, the energy storage system 100 includes components such as sensors to take measurements of the cells 104 during charging and/or discharging.

In some examples, the energy storage system 100 includes a power converter and an AC interconnect electrically connected to the power converter. In some examples, the power converter is configured to convert direct current (“DC”) voltage from the energy storage system 100 to alternating current (“AC”) voltage that may be suitable for a particular application. In some examples, the AC interconnect provides an interface between the energy storage system 100 and a utility grid.

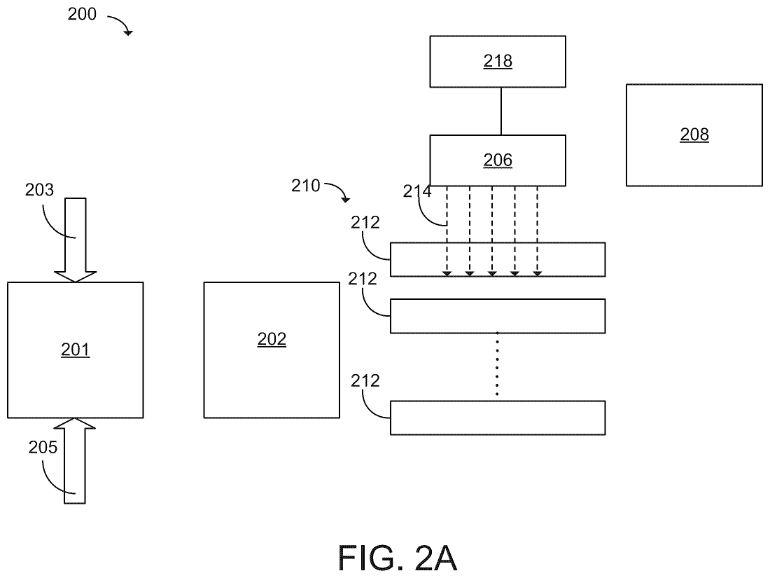

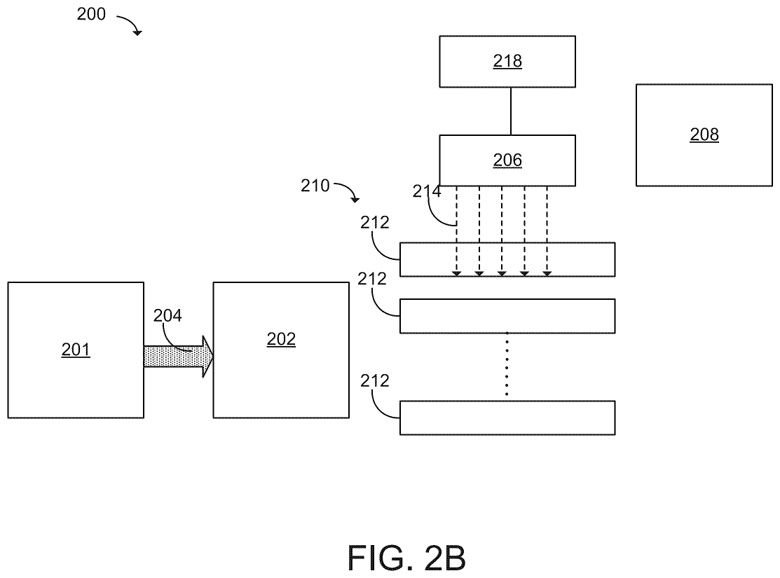

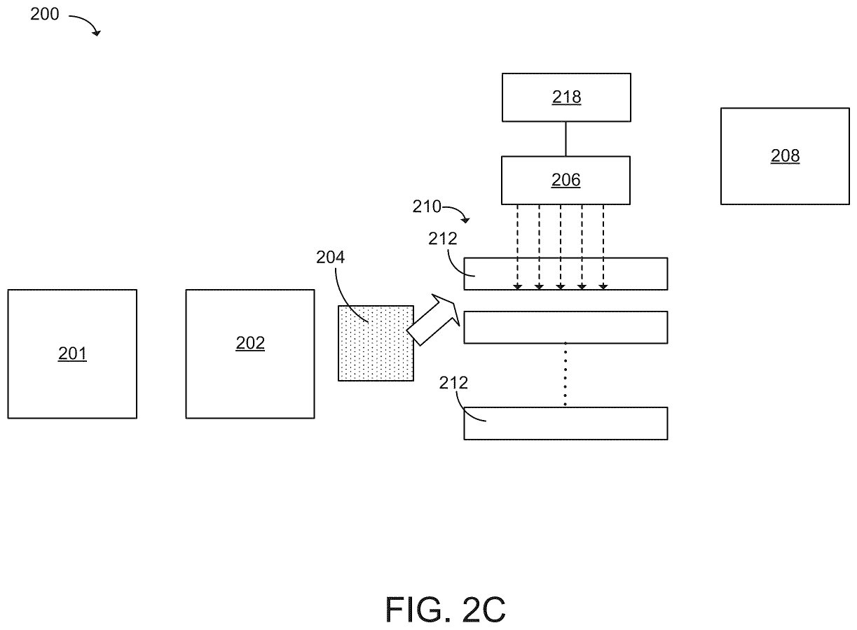

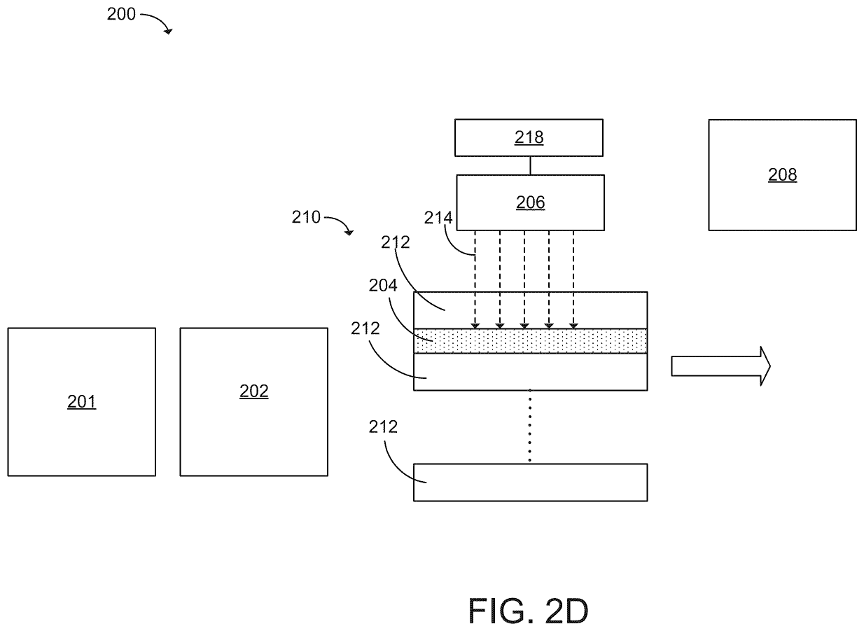

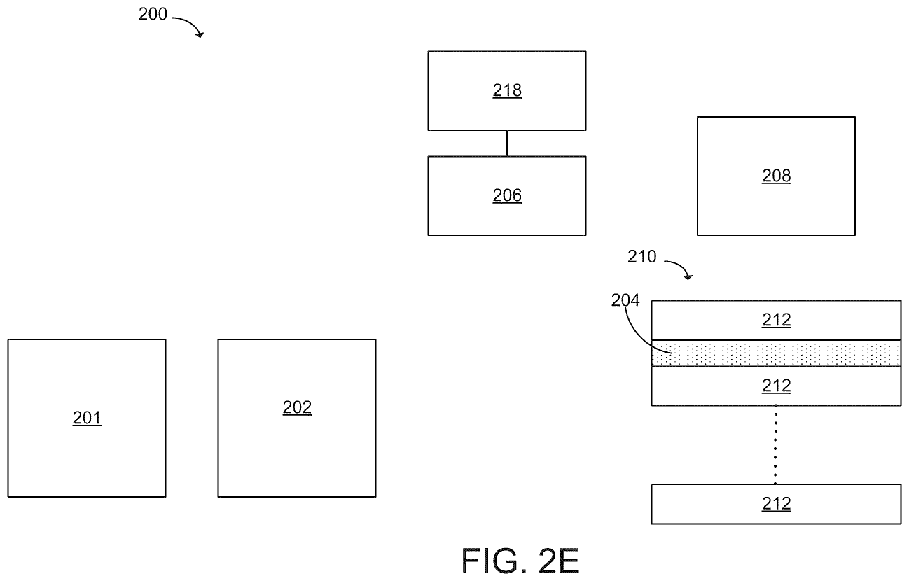

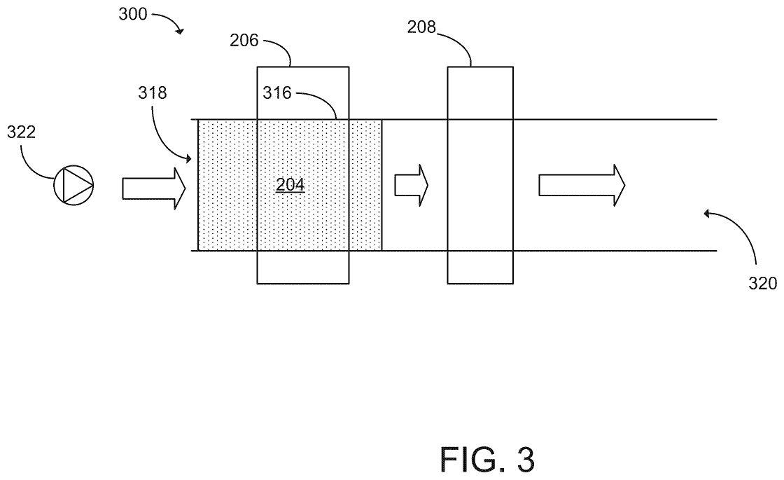

Referring to FIGS. 2A-D and FIGS. 3-7, examples of the present disclosure include systems and methods for processing, carbonizing, and activating carbonaceous material 204 for use in energy storage applications, such as for use in the energy storage system 100 illustrated in FIG. 1.

As used herein, the term “carbonaceous material” refers to any material including carbon. In some examples, carbonaceous material 204 includes a mixture of carbon and other materials. In one or more examples, the carbonaceous material 204 includes waste materials, such as plastic waste, agricultural residues, grains, food waste, beverage waste, human waste, industrial waste, sawdust, tires, pyrolytic carbon (e.g., from hydrogen production), coal, coal waste (e.g., unutilized coal), algae, seaweed, or a combination thereof. Methods of the present disclosure include one or more steps of deriving carbon from such carbonaceous waste materials. In some examples, carbonaceous material 204 includes a mixture of activated carbon and another material. In some examples, carbonaceous material 204 includes a combination of two streams of different materials, such as a first material 203 and a second material 205, as shown in FIG. 2A.

Referring to FIGS. 2A-E, in some examples, a system 200 for processing carbon includes a combination unit 201, a purification unit 202, an energy emitter 206, and an activation unit 208. Referring to FIG. 2A, in some examples, the combination unit 201 is configured to combine multiple streams of material. In some examples, the combination unit receives and combines a first stream of a first material 203 and a second stream of a second material 205. As used herein, a “stream of” material includes a flowing material. A stream of material includes, in some examples, material being moved and/or manipulated by a component of a system described herein. For example, referring to FIG. 2D, the press 210 can receive, transport, hold, and/or manipulate the carbonaceous material 204 as a combined stream of carbonaceous material 204. In some examples, the first material 203 and the second material 205 are different. The first material 203 and the second material 205 have at least one different parameter. In some examples, the differing parameter includes: a carbon content, a cellulose content, a chemical composition, a source of the material, or any combination thereof. In some examples, combining the two streams of material helps to facilitate use of materials that may not otherwise be suitable for use. In some examples, the first material 203 and the second material 205 are of different material types, different chemical compositions, and/or a combination thereof.

In some examples, a first material 203 has a carbon content that is higher than a second material 205. In some examples, the carbon content is a percentage of the material by mass that is composed of carbon. In some examples, the first material 203 includes a type of waste material having a carbon content of at least 30 percent. In some examples, the carbon content is not greater than 50 percent. In some examples, the second material 205 includes a type of material having a carbon content that is lower than the carbon content of the first material 203. For example, the second material 205 has a carbon content of less than 30 percent.

In one or more examples, combining two streams of different materials (e.g., the first material 203 and the second material 205) helps to efficiently utilize available waste materials (e.g., in a first stream of the first material 203) while providing structure and/or chemical properties desired for a particular application (e.g., in a second stream of the second material 205). In some examples, the first material 203 has a cellulose content that is different from the cellulose content of the second material 205. In some examples, the first material 203 has a cellulose content that is lower than the cellulose level of the second material 205. In some examples, a cellulose content includes a percentage of the material by mass that is composed of cellulose. In some examples, the cellulose content of the first material 203 is lower than a threshold cellulose content for use in a particular application, while the cellulose content of the second material 205 is higher. In one or more examples, the first material 203 has a cellulose content of approximately 30 percent by mass, or not less than 20 percent but less than 40 percent, and the second material 205 has a higher cellulose content of not less than 40 percent by mass. In some examples, the second material 205 has a cellulose content of not less than 60 percent and not greater than 99 percent. In some examples, the first material 203 includes human waste, while the second material 205 includes cloth and/or agricultural residue.

In some examples, the combination unit 201 combines the two streams of materials 203, 205 into a stream of carbonaceous material 204. In some examples, the combination unit 201 includes two inlets, each inlet receiving a different stream of material. In one or more examples, the combination unit includes any means of combining streams from the two inlets, such as a passage formed at a juncture of two passages fluidically connected to the two inlets. In some examples, the combination unit includes a mixing unit.

Referring to FIGS. 2B-C, in some examples, the carbonaceous material 204 is fed into and/or exposed to the purification unit 202 prior to exposure to the energy emitter 206 and/or activation unit 208. In some examples, the purification unit 202 includes any component configured to perform a pre-processing step on the carbonaceous material 204. In some examples, a pre-processing step includes a step performed prior to a carbonization step. The purification unit 202, in some examples, is configured to remove an impurity, a contaminant, or a combination thereof from the carbonaceous material. In some examples, the purification unit 202 is configured to remove only a portion of an impurity, contaminant, or combination thereof. In some examples, the removed portion of the impurity, contaminant, or combination thereof, is no more than at least one of the following percentages of the total impurity by weight and/or volume: 95 percent, 90 percent, 85 percent, 80 percent, or 75 percent. In some examples, the removed portion of the impurity, contaminant, or combination thereof, is no less than at least one of the following percentages of the total impurity by weight and/or volume: 5 percent, 10 percent, 15 percent, 20 percent, or 25 percent.

Impurities include, for example, inorganic impurities, such as mineral matter (e.g., inorganic substances such as silica, alumina, iron oxides, calcium compounds, or any combination thereof). In some examples, the impurities include a metallic material within the carbonaceous material 204. In some examples, the impurities originate from the source material, such as the waste material. In some examples, the impurities include organic impurities, such as volatile organic compounds (e.g., hydrocarbons, alcohols, aldehydes, or any combination thereof), mixtures of organic compounds, and/or residual biomass components (e.g., lignin, cellulose, hemicellulose, or any combination thereof).

In some examples, the purification unit 202 includes a physical component, such as a filter, a sieve, a centrifuge, a magnet, a vaporizer, a heating element, or any combination thereof. Additionally, or alternatively, in some examples, the purification unit 202 is configured to remove the impurity via at least one of: acid washing, base washing, oxidation, and/or reduction. In some examples, the purification unit 202 includes components configured to expose the carbonaceous material 204 to chemical solutions as part of the purification process. In some examples, the chemical solution includes an acid formulated and/or selected to dissolve certain inorganic impurities, such as metal oxides, in the carbonaceous material 204. Acids include, in some examples, hydrochloric acid, sulfuric acid, or a combination thereof. In some examples, the chemical solution includes an alkaline solution formulated and/or selected to remove acidic impurities from the carbonaceous material 204. In some examples, the alkaline solution includes sodium hydroxide. In one or more examples, the purification unit 202 includes components configured to expose the carbonaceous material 204 to an oxidizing agent formulated and/or selected to oxidize and/or remove organic impurities. In some examples, the oxidizing agent includes hydrogen peroxide, nitric acid, or a combination thereof. In some examples, the purification unit 202 includes components configured to expose the carbonaceous material 204 to a reducing agent formulated and/or selected to reduce metal oxides in the carbonaceous material to a metallic form, which can then be removed. In one or more examples, the reducing agents include hydrogen gas, carbon monoxide, or any combination thereof.

Although not shown in the Figures, in some examples, the system 200 includes a mixing unit configured to form a mixture of the pre-processed carbonaceous material 204 and water. In some examples, the water is in liquid form. In other examples, the water is in a vapor form. In some examples, the mixing unit is configured to form the mixture before a carbonization step and/or before the carbonaceous material 204 is exposed to the energy emitter 206. In some examples, the mixing unit includes a container into which the water and the pre-processed carbonaceous material 204 is added. In one or more examples, the mixing unit includes one or more of: a tank, a stirrer, or a rotating component such as an impeller. In some examples, the mixing unit is configured to add a binder to the carbonaceous material.

In some examples, the mixing unit is configured to adjust a parameter of the carbonaceous material 204. In one or more examples, the parameter includes a hydration level, a cellulosic content, or any combination thereof. In some examples, the parameter is adjusted according to a desired performance of the outputted material (e.g., a desired performance metric of the electrode 106). In some examples, the mixing unit is configured to adjust a size of the carbonaceous material 204. In various examples, the mixing unit includes a chopper, grinder, or combination thereof configured to reduce the volume of the carbonaceous material 204.

In some examples, the mixing unit is configured to add a catalyst to the carbonaceous material 204. In one or more examples, catalysts include a catalyst derived from biomass, including, for example, sulfonated lignin, furfural, phosphorous, potassium, magnesium, calcium, carboxylic acid, an enzyme, or a combination thereof. In some examples, the mixing unit is configured to add an activation precursor to the carbonaceous material 204. In some examples, the activation precursor is formulated and/or selected to facilitate activation of the carbonaceous material 204, such as potassium. In some examples, the activation precursor is sourced from food waste. In some examples, the activation precursor is selected and/or formulated to help facilitate concurrent activation and carbonization of the carbonaceous material 204.

Any steps described herein as being performed on the carbonaceous material 204 include, in some examples, performing such steps or similar steps on the mixture.

Referring to FIG. 2B, in some examples, the purification unit 202 removes impurities from the carbonaceous material 204 before the carbonaceous material 204 is exposed to energy emitted from the energy emitter 206. In some examples, the energy emitter 206 is configured to at least partially carbonize the carbonaceous material 204 by exposing the carbonaceous material 204 to energy 214. As used herein, the term “carbonization” refers to any step of a process that helps to make the carbonaceous material more carbon-rich. In some examples, carbonization includes the step of removing impurities from the carbonaceous material 204 performed by the purification unit 202. In such examples, the energy emitter 206 is configured to further carbonize and/or activate the carbonaceous material 204. In some examples, the energy 214 emitted by the energy emitter 206 includes one or more of: heat, electricity, microwave radiation, sonic energy, and/or light. In some examples, the energy emitter 206 obtains the energy 214 from an energy source 218, such as a renewable energy source. In some examples, the energy source 218 is part of the energy emitter 206. In other examples, the energy source 218 is separate from the energy emitter 206. In some examples, the energy source 218 is configured to supply recycled energy. In one or more examples, recycled energy includes energy emissions from cooling the carbonaceous material 204 during a processing step, waste energy from an industrial process, or a combination thereof. In some examples, the energy source 218 supplies energy in the form of biogas. In one or more examples, the energy source 218 is configured to supply renewable energy, such as solar thermal energy, which can then be converted into heat by the energy emitter 206. In some examples, the energy source 218 is configured to supply captured emissions a previous carbonization and/or activation cycle of the system 200, as described herein, to be recycled. Such emissions include, for example, carbon dioxide, methane, hydrogen, or a combination thereof.

In some examples, the energy emitter 206 is configured to emit the energy 214 such that it penetrates an additional component to reach the carbonaceous material 204. In some examples, as illustrated in FIG. 2D, the energy 214 is applied to the carbonaceous material 204 through one or more plates 212 between which the carbonaceous material 204 is held.

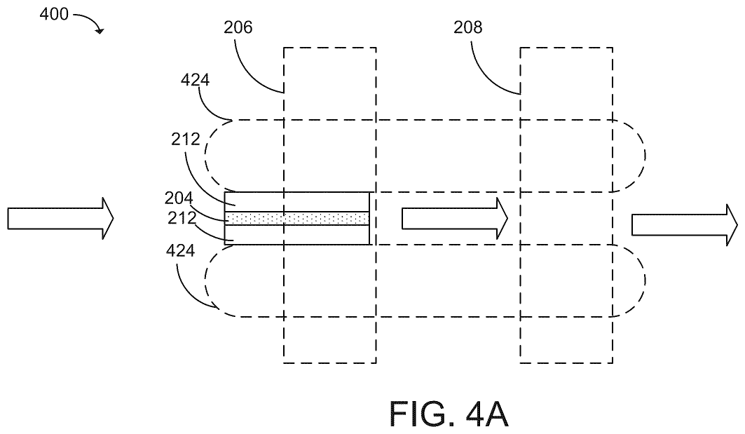

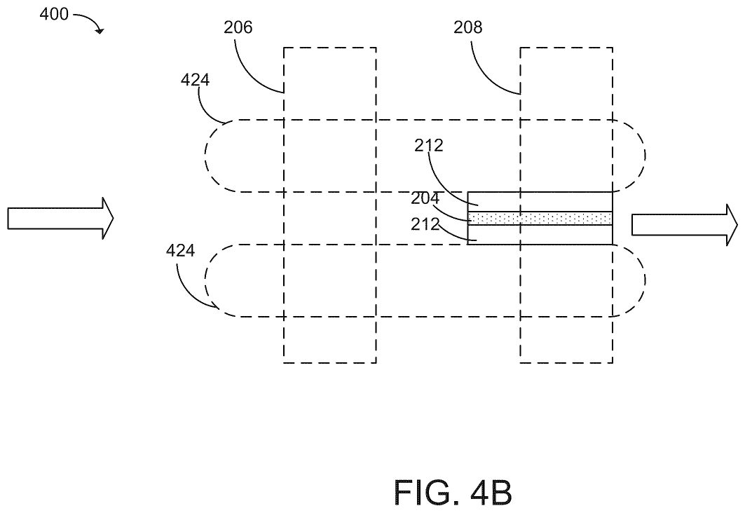

In some examples, the plates 212 plates of a multi-plate press 210. In one or more examples, the press 210 includes at least two plates 212. In some examples, the press 210 includes three or more plates 212. The plates 212 are configured to receive the carbonaceous material 204 between adjacent plates 212 of the press 210. In some examples, the press 210 is configured to apply pressure to the carbonaceous material 204 via the plates 212. Referring to FIGS. 4A-B, in some examples, the press 210 is configured to move the carbonaceous material 204 through various stations of processing. In some examples, the plates 212 are porous and/or permeable by the energy 214. In some examples, the press 210 includes rollers in addition to or alternative to the plates 212. In one or more examples, the press 210 includes conveyor belts such as those illustrated in FIGS. 4A-B. In various examples, the press 210 is configured to receive the carbonaceous material 204 for continuous processing. In some examples, the press 210 is configured to receive the carbonaceous material 204 for batch processing.

In some examples, the energy emitter 206 is configured to heat the carbonaceous material 204 to a threshold temperature. The threshold temperature, in some examples, is between and inclusive of 100 and 900 degrees Celsius (° C.). In some examples, the threshold temperature is between and inclusive of 100 to 200° C. IN some examples, the energy emitter 206 is configured to generate pressure within the carbonaceous material 204 by heating water within the carbonaceous material 204. In some examples, the pressure generated by the energy emitter 206 is between and inclusive of 10 to 100 bar. In some examples, the energy emitter 206 is configured to perform pyrolysis on the carbonaceous material 204.

In some examples, the energy emitter 206 is configured to expose the carbonaceous material 204 to the energy 214 in the absence of oxygen. In some examples, the energy emitter 206 includes a container, such as a pyrolysis reactor, into which the carbonaceous material 204 is fed. In some examples, the energy emitter 206 includes a pyrolysis reactor with a reaction chamber sealed to prevent oxygen from entering the reaction chamber. In some examples, the pyrolysis reactor includes reactor walls and/or other components that are made of materials that are resistant to oxygen permeation. In some examples, the energy emitter 206 includes a container into which the carbonaceous material 204 is fed, and the container includes an inlet for receiving an inert gas. In some examples, the inert gas is formulated and/or selected to displace oxygen. The inert gas includes, for example, nitrogen, argon, or a combination thereof. In some examples, the energy emitter 206 includes a vacuum configured to remove oxygen from a pyrolysis reactor or other containers of the energy emitter 206. In some examples, the system 200 includes an oxygen supply and components configured to supply a controlled, limited oxygen supply to a reaction chamber of the energy emitter 206.

Referring to FIG. 2E, in some examples, the activation unit 208 is configured to convert at least some of the carbonaceous material 204 into activated carbon. As used herein, the term “activation” refers to any step of a process of increasing a surface area and/or porosity of a carbonaceous material 204. Referring to FIG. 2D, in some examples, the activation unit 208 performs the activation after the carbonaceous material 204 is at least partially carbonized (e.g., after the carbonaceous material 204 is exposed to the energy emitter 206). In some examples, the steps of activation and carbonization at least partially overlap. In some examples, the activation unit 208 is configured to perform the activation concurrently with the carbonaceous material 204 being exposed to the energy 214 from the energy emitter 206. In some examples, the activation unit 208 includes the energy emitter 206 and/or an additional energy emitter.

In some examples, after the carbonaceous material 204 has been activated by the activation unit 208, the carbonaceous material 204 has a carbon content by mass of not greater than 95 percent. In some examples, the carbonaceous material 204 has a carbon content of not greater than 90 percent. In some examples, the carbonaceous material 204 has a carbon content of not less than 60 percent and not greater than 90 percent. In some examples, the carbonaceous material has a carbon content of not less than 60 percent and not greater than 85 percent. In some examples, the carbonaceous material 204 has a carbon content of not less than 60 percent and not greater than 80 percent. In some examples, the carbon content of the carbonaceous material 204 when the carbonaceous material 204 is formed into an electrode 106 is at least one of: not greater than 95 percent, not greater than 90 percent, not less than 60 percent and not greater than 90 percent, not less than 60 percent and not greater than 85 percent, or not less than 60 percent and not greater than 80 percent.

In some examples, the activation unit 208 is configured to convert the carbonaceous material 204 into activated carbon via physical activation, chemical activation, electrochemical activation, or a combination thereof. In some examples, physical activation includes exposing the carbonaceous material 204 to additional energy, such as heat. In one or more examples, the activation unit 208 is configured to heat the carbonaceous material 204 to a higher temperature than the energy emitter 206 heats the carbonaceous material to. In some examples, the energy emitter 206 heats the carbonaceous material 204 to a first temperature of less than 800 degrees Celsius (° C.). In some examples, the activation unit 208 is configured to heat the carbonaceous material 204 to a second temperature higher than the first temperature. In some examples, the second temperature is between and inclusive of 800 and 1000° C. In some examples, the activation unit 208 treats the heated carbonaceous material 204 with a gas, such as steam, carbon dioxide, or a combination thereof.

In some examples, a chemical activation process involves an activation unit 208 impregnating the carbonaceous material 204 with a chemical activating agent and heating the impregnated carbonaceous material 204. In some examples, impregnating the carbonaceous material 204 with the chemical activating agent includes immersing the carbonaceous material 204 in the chemical activating agent (e.g., in a container within the activation unit 208) for a period of time sufficient to allow the chemical activating agent to penetrate pores of the carbonaceous material. In some examples, the chemical activating agent includes an acid, a strong base, a salt, an alkali metal hydroxide, potassium hydroxide, phosphoric acid, sodium hydroxide, potassium carbonate, calcium chloride, zinc chloride, or a combination thereof. In some examples, the chemical activating agent is selected and/or formulated to react with the carbon when heated, creating pores and increasing the surface area of the carbonaceous material 204. In some examples, the activation unit 208 includes a dispenser configured to dispense the chemical reacting agent. In some examples, the dispenser is a diffuser configured to diffuse the chemical reacting agent. In some examples, the activation unit 208 also includes a vacuum configured to facilitate deeper penetration of the chemical reacting agent.

In some examples, after impregnating the carbonaceous material 204 with the chemical reacting agent, the activation unit 208 is configured to heat the impregnated carbonaceous material 204. In some examples, the temperature is between and inclusive of 500 and 800° C. In some examples, this heating step is in addition to heating performed by the energy emitter 206 and/or is also performed by the energy emitter 206.

In some examples, the activation unit 208 includes components configured to perform both a primary activation process and a secondary activation process. In some examples, the primary activation process is performed on the mixture of water and carbonaceous material 204. In some examples, the system 200 includes a separator configured to separate carbon from the mixture. In some examples, the separator includes at least one of: a filter, a vacuum, a centrifuge, or a dryer (e.g., a freeze dryer, an air dryer, an oven, or a combination thereof). In some examples, the separator separates water from the mixture by allowing the carbon to settle at the bottom of a container and pouring and/or otherwise removing water from the container.

In some examples, the activation unit 208 performs a secondary activation process subsequent to the primary activation process. The secondary activation process is performed on the carbonaceous material 204 that has been separated from the water of the mixture.

In some examples, the system 200 is configured to perform an additional carbonization step subsequent to activation of the carbonaceous material 204. In some examples, the additional carbonization step is performed using at least one of the energy emitter 206 and the activation unit 208.

In some examples, the system 200 is configured to pelletize the activated carbonaceous material 204 before subjecting the carbonaceous material 204 to additional carbonization. In some examples, the system 200 includes a pelletization unit. In some examples, the pelletization unit is configured to shape the activated carbonaceous material 204 through, for example, compression. In some examples, the pelletization unit forms the carbonaceous material 204 into pellets of a substantially cylindrical, spherical, and/or circular shape. In some examples, the pelletization unit forms the carbonaceous material 204 into pellets of non-circular shapes, such as rectangles, sheets, and/or rectangular prisms. In some examples, pelletizing the carbonaceous material 204 includes at least one of: mixing a binder (e.g., a starch, clay, carbon black, epoxy, adhesive, or combination thereof) with the activated carbonaceous material 204, extruding the carbonaceous material 204 through a die, drying the carbonaceous material 204, apply pressure to the carbonaceous material 204, compressing the carbonaceous material 204 between two rollers and/or between two conveyor belts, cutting a sheet of the carbonaceous material 204 into pellets, and/or feeding the carbonaceous material 204 into a rotating drum. In some examples, the pelletization unit includes at least one of: a binder dispenser, a die, a dryer, two or more rollers, two or more conveyor belts, a cutter, and a rotating drum.

In some examples, the system 200 is configured to transform the carbonaceous material 204 into graphite. In some examples, the system 200 includes a graphitization unit. In other examples, the energy emitter 206 and/or another unit configured to perform the secondary carbonization process is configured to perform the graphitization. In one or more examples, the system 200 is configured to apply heat to the carbonaceous material 204 after activation and/or pelletization to transform the carbonaceous material 204 into graphite. For example, the energy emitter 206 can apply energy 214 in the form of heat to the activated carbonaceous material 204. In some examples, the carbonaceous material is heated to a temperature of not less than 1000° C. In some examples, the temperature is not less than 1000° C. and not greater than 3000° C. In one or more examples, the temperature is sufficient to cause carbon atoms in the carbonaceous material 204 to rearrange and form layered crystal planes. In some examples, graphitizing the carbonaceous material 204 is accelerated using a catalyst, such as iron, nickel, or a combination thereof. In one or more examples, the graphitization and secondary carbonization steps are combined, performed concurrently, and/or performed by common components of the system 200 (e.g., the energy emitter 206). In some examples, graphitizing the carbonaceous material 204 causes the carbonaceous material 204 to take on a form of graphitic carbon, such as graphene or carbon nanotubes.

In some examples, the system 200 is configured to remove residual impurities from the carbonaceous material 204. In some examples, after the secondary carbonization and graphitization, the carbonaceous material 204 is washed and/or rinsed to remove a remaining impurity. In some examples, the system 200 includes a washing unit. In some examples, the washing unit includes the purification unit 202 and/or similar components. In some examples, the washing unit includes a water dispenser, such as a valve or a hose, configured to spray the carbonaceous material 204 with water. In some examples, the water is heated by a heating element of the system 200. The water can be in liquid and/or steam form. In some examples, the dispenser is configured to dispense a chemical solution to help remove the impurity. The chemical solution includes, in some examples, at least one of: acid, hydrochloric acid, sulfuric acid, nitric acid, or sodium hydroxide. In one or more examples, the washing unit is configured to dispense an organic solvent formulated and/or selected to help remove an impurity.

In some examples, the system 200 is configured to form the carbonaceous material 204 into electrodes 106 immediately after washing and without drying the carbonaceous material. For example, an electrode 106 for use in a cell 104 with an aqueous electrolyte solution 110 may not need to be dried before formation. In other examples, the system 200 includes one or more drying elements configured to dry the carbonaceous material 204 after washing.

In some examples, the system 200 is configured to functionalize the carbonaceous material 204 with moieties, such as amines and hydroxyls, to help enhance properties such as hydrophilicity, facilitate charge transfer, improved pore structure, reduce self-discharge, and improve chelation of metals. In some examples, the system 200 includes a functionalization unit configured to expose the carbonaceous material 204 to the moieties. In some examples, the functionalization unit includes a dispenser configured to dispense a moiety.

In some examples, the system 200 is configured to form the carbonaceous material 204 into an electrode, such as the electrode 106 shown in FIG. 1. In some examples, the system 200 includes a formation unit. In some examples, the formation unit includes a mixer that mixes the carbonaceous material 204 with a binder, such as polyvinylidene fluoride. In one or more examples, the mixer also mixes the carbonaceous material 204 with a conductive additive, such as graphite powder, to help improve electrical conductivity. In one or more examples, the mixer forms a slurry out of the carbonaceous material 204 and these additive(s) and binder(s). In one or more examples, the formation unit is configured to dispense the slurry onto a current collector, such as a metallic current collector, and spread the slurry across the current collector. In some examples, the formation unit includes a blade to spread the slurry across the current collector. In one or more examples, the formation unit also includes a drying element to dry the electrode. In some examples, the formation unit is configured to adjust a thickness of the electrode.

In some examples, the system 200 recycles byproducts of a particular step of processing to be used in another step. In one or more examples, leftover water used by the washing unit is fed from the washing unit to the mixing unit and re-used to form a mixture of water and carbonaceous material 204.

Examples of the present disclosure include performing steps of methods for processing carbonaceous material 204 (e.g., methods 600 and 700 shown in FIGS. 6 and 7) and/or operations described above in connection with the system 200 in a batch process, a continuous process, or a combination thereof.

Referring to FIG. 3, in some examples, a system 300 for processing carbonaceous material 204 continuously is an embodiment of the system 200. In some examples, the system 300 includes components of the system 200, such as the energy emitter 206 and/or the activation unit 208, but includes additional components, such as a container 316 and a pump 322 configured to pump the carbonaceous material 204 into and/or through the container 316. In some examples, the system 300 is a tubular flow reactor.

In some examples, the container 316 includes two open ends. In some examples, the container 316 includes an inlet 318 located proximate to an end of the container 316 and an outlet 320 located proximate to an opposite end of the container 316. In some examples, the container 316 is substantially tubular and/or cylindrically shaped.

In some examples, the pump 322 is configured to push the carbonaceous material 204 into the container 316 through the inlet 318. In some examples, the pump 322 pushes and/or draws the carbonaceous material 204 from a purification unit 202 to the container 316. In some examples, the pump 322 moves the carbonaceous material 204, which includes a mixture of carbonaceous material and water, from a mixing unit external to the container 316 and into the container. In other examples, the container 316 includes a water inlet, and a mixture of carbonaceous material 204 and water is formed as the carbonaceous material moves through the container 316. In some examples, the pump 322 moves the carbonaceous material 204 through the container 316, and various components of the system 300 perform operations of the carbonization and/or activation processes described herein on the carbonaceous material 204 as the carbonaceous material 204 moves through the container 316.

In some examples, the energy emitter 206 and/or activation unit 208 include components positioned outside of the container 316. In some examples, the container 316 is made of a material permeable to energy emitted by the energy emitter 206 and/or activation unit 208. In some examples, the energy emitter 206 and/or activation unit are contained within the container 316.

In some examples, the energy emitter 206 is positioned to carbonize the carbonaceous material 204 (e.g., by exposing the carbonaceous material 204 to energy 214) while the carbonaceous material 204 is within the container 316. In some examples, the energy emitter 206 carbonizes the carbonaceous material 204 as the carbonaceous material 204 moves through the container 316. In some examples, after the carbonaceous material 204 moves past the energy emitter 206, it moves toward the activation unit 208. In some examples, the activation unit 208 converts the carbonaceous material 204 into activated carbon while the carbonaceous material 204 is within the container 316. In some examples, the carbonaceous material 204 is activated as it moves toward the outlet 320.

In some examples, each component described above in connection with the system 200 is included in the system 300 and positioned at different stations along the container 316 such that the carbonaceous material 204 is subjected to different processing steps as it moves through the container 316.

Although FIG. 3 illustrates a pump 322, examples of the present disclosure are not so limited. In some examples, components of the system 300 are positioned such that the carbonaceous material 204 is gravity fed through the container 316. In some examples, the system 300 includes a vacuum configured to draw the carbonaceous material into, through, and out of the container 316.

In some examples, a separator is positioned within the container 316 to separate water from activated carbonaceous material 204. In various example, the container 316 includes one or more separate channels through which the separated carbon and water can travel.

Referring to FIGS. 4A-B, examples of the present disclosure include a system 400 for continuous processing of carbonaceous materials 204 via one or more conveyor belts 424. In some examples, the system 400 is an embodiment of the system 200. In some examples, the system 400 includes all or some of the elements of the system 200, such as the energy emitter 206 and the activation unit 208, but also includes additional components, such as one or more conveyor belts 424.

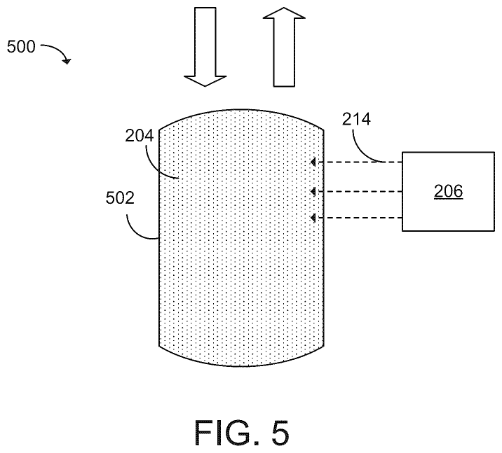

In some examples, the conveyor belts 424 are configured to move the carbonaceous material 204 through and/or past different components of the system 400 to subject the carbonaceous material 204 to processing steps as the carbonaceous material 204 is transported by the conveyor belt 424. In some examples, the carbonaceous material 204 is transported between two conveyor belts 424. In one or more examples, the two conveyor belts 424 are adjacent to each other. One conveyor belt 424 may be arranged above another conveyor belt 424 such that the carbonaceous material 204 is interposed between the two conveyor belts 424. In some examples, rather than making direct contact with the conveyor belts 424, the carbonaceous material 204 is within a container. In some examples, the system 400 includes a number of plates 212 between which the carbonaceous material 204 is interposed. In some examples, the plates 212 are permeable to energy applied to the carbonaceous material 204. In one or more examples, the plates 212 are interposed between two conveyor belts 424 moving together. In various examples, the conveyor belts 424 move the carbonaceous material 204 and plates 212 in together in the same direction. The plates 212 and carbonaceous material then pass through various stations, such as the energy emitter 206 and the activation unit 208, to experience different steps of processing. Although FIG. 4A only shows two plates 212 and one collection of carbonaceous material 204 interposed between the two plates 212, examples of the system 400 also includes more than two plates 212 stacked vertically, with separated portions of the carbonaceous material 204 interposed between pairs of plates. In some examples, carbonaceous material 204 that was originally separated into batches (e.g., for processing as described in connection with FIG. 5) can be interposed between the plates 212 on a batch-by-batch basis, and multiple batches can be moved together along the conveyor belt 424 for continuous processing.

Referring to FIG. 4A, in some examples, the conveyor belts 424 rotate in opposite radial directions (e.g., with one rotating clockwise and another counter-clockwise) to move the carbonaceous material 204 into an area of exposure of the energy emitter 206. The dashed lines in FIG. 4A represent one embodiment of an area of exposure of the energy emitter. In some examples, the conveyor belts 424 move at the same or similar speeds.

Referring to FIG. 4B, the conveyor belts 424 move the carbonaceous material 204 toward an area of exposure of the activation unit 208 to allow the carbonaceous material 204 to be converted into activated carbon.

Although FIGS. 4A-B illustrate two conveyor belts 424, examples of the present disclosure are not so limited. In some examples, the system 400 includes only one conveyor belt 424. In other examples, the system 400 includes more than two conveyor belts, and multiple batches of carbonaceous material 204 are processed concurrently. Although FIGS. 4A-B illustrate the conveyor belts 424 moving the carbonaceous material 204 through operations performed by the energy emitter 206 and the activation unit 208, examples of the present disclosure are not so limited. The system 400 can include any of the units described above in connection with the system 200, and the conveyor belts 424 can be configured to move the carbonaceous material 204 such that operations of any of the above-described units may be performed.

Referring to FIG. 5, examples of the present disclosure include a system 500 for batch processing of the carbonaceous material 204. In some examples, the system 500 is an embodiment of the system 200. In some examples, some steps of processing the carbonaceous material 204 are performed by the system 500 in batches, while other steps are performed continuously, such as by the systems 300 and/or 400.

In some examples, the system 500 includes one or more reactors 502. In some examples, the reactors 502 are large, three-dimensional reactors. In other examples, the reactors 502 include smaller, more two-dimensional reactors.

In some examples, the system 500 is configured to separate the carbonaceous material 204 into batches and perform multiple steps of the carbonization and/or activation processes on a single batch before performing any such steps on another batch. In some examples, the reactor 502 is configured to collect the carbonaceous material and hold it together for a specified time interval. In some examples, the specified time interval is a time interval for completing a particular step of processing the carbonaceous material. In some examples, each step of the process is performed with the carbonaceous material 204 within the reactor 502.

In some examples, the carbonaceous material 204 is fed into the reactor 502 and held in the reactor 502 for a specified time period. In some examples, the energy emitter 206 applies energy 214 to the carbonaceous material 204 while the carbonaceous material 204 is within the reactor 502 throughout that time period, thus carbonizing the carbonaceous material 204 within the reactor 502. In some examples, when a processing step is performed within the reactor 502, one or more by-products, such as water or an impurity of the carbonaceous material 204, are extracted from the reactor for disposal and/or re-use in other steps of processing. In some examples, the reactor 502 includes an inlet for receiving material and an outlet for extracting material.

Referring to FIG. 6, examples of the present disclosure include a method 600 for processing carbonaceous material 204. In some examples, various steps of the method 600 are performed by components of the systems 200, 300, 400, and/or 500, as described herein. In some examples, the method 600 begins and, at step 601, combines a first stream of a first carbonaceous material and a second stream of a second carbonaceous material into a combined stream of carbonaceous material. A parameter of the first carbonaceous material has a first value and the parameter of the second carbonaceous material has a second value that is different than the first value. In some examples, the method 600, at step 602, removes only a portion of an impurity, a contaminant, or a combination of the impurity and the contaminant from the combined stream of carbonaceous material. In some examples, at step 604, the method 600 carbonizes the combined stream of carbonaceous material 204 by exposing the combined stream of carbonaceous material to energy in the form at least one of: heat, electricity, microwave radiation, or light. In some examples, at step 606, the method 600 converts the combined stream of carbonaceous material 204 into activated carbon.

Referring to FIG. 7, examples of the present disclosure include a method 700 for processing carbonaceous material 204. In some examples, various steps of the method 700 are performed by components of the systems 200, 300, 400, and/or 500, as described herein. In some examples, the method 700 is an embodiment of the method 600.

In one or more examples, the method 700 begins and, at step 701, combines a first stream of a first carbonaceous material and a second stream of a second carbonaceous material into a combined stream of carbonaceous material. A parameter of the first carbonaceous material has a first value and the parameter of the second carbonaceous material has a second value that is different than the first value. In some examples, the method 700, at step 702, removes only an impurity, contaminant, or combination of the impurity and the contaminant from the combined stream of carbonaceous material. In some examples, at step 703, the method 700 mixes the combined stream of carbonaceous material 204 with water to form a mixture. In some examples, the method, at step 704, carbonizes the combined stream of carbonaceous material 204 by exposing the combined stream of carbonaceous material 204 to energy in the form of at least one of: heat, electricity, microwave radiation, sonic energy, or light. The carbonaceous material 204 includes the mixture of step 703. In some examples, step 704 includes carbonizing the combined stream of carbonaceous material 204 by performing a hydrothermal carbonization process on the carbonaceous material 204. The method 700, at step 706, converts the combined stream of carbonaceous material 204 into activated carbon.

In some examples, the method 700 performs steps 704 and 706 simultaneously and/or concurrently. In some examples, the step 704 of carbonizing the combined stream of carbonaceous material 204 includes performing a primary carbonization process. In some examples, the step 706 includes performing a primary activation process that includes converting the mixture into an activated mixture of water and activated carbon.

In some examples, the method 700 includes separating, at step 708, the activated carbon from the activated mixture to create separated carbon. The method 700 includes, at step 710, activating the separated carbon in a secondary activation process. In some examples, the method 700 also includes, at step 714, performing a secondary carbonization process on the separated carbon. In some examples, the method 700 includes, at step 712, pelletizing the separated carbon to create pelletized activated carbon prior to performing the secondary carbonization process. The secondary carbonization process is performed on the pelletized activated carbon.

In some examples, the method 700 includes, at step 716, forming the activated carbon into an electrode. In some examples, the electrode is an electrode 106 of a plurality of discrete electrodes. In some examples, the method 700 also includes forming the activated carbon into a plurality of discrete electrodes and forming a plurality of cells of an energy storage system. In some examples, each cell of the plurality of cells includes an electrode of the plurality of discrete electrodes. In some examples, the method 700 includes electrically connecting the plurality of cells in a series connection.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” or “approximately” in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A method of processing carbonaceous material, the method comprising:
combining a first stream of a first carbonaceous material and a second stream of a second carbonaceous material into a combined stream of carbonaceous material, wherein a parameter of the first carbonaceous material has a first value and the parameter of the second carbonaceous material has a second value that is different than the first value;
removing only a portion of an impurity, a contaminant, or a combination of the impurity and the contaminant from the combined stream of carbonaceous material;
carbonizing the combined stream of carbonaceous material by exposing the combined stream of carbonaceous material to energy in the form at least one of: heat, electricity, microwave radiation, or light; and
converting the combined stream of carbonaceous material into activated carbon.

2. The method of claim 1, wherein the combined stream of carbonaceous material is converted into the activated carbon concurrently with the combined stream of carbonaceous material being carbonized.

3. The method of claim 1, wherein the parameter comprises a carbon content and the first value comprises a carbon content different from a carbon content of the second value.

4. The method of claim 1, wherein the parameter comprises a cellulose content and the first value comprises a cellulose content different from a cellulose content of the second value.

5. The method of claim 1, wherein the activated carbon has a carbon content not greater than 90 percent.

6. The method of claim 1, further comprising mixing the combined stream of carbonaceous material with water to form a mixture, wherein carbonizing the combined stream of carbonaceous material comprises exposing the mixture to the energy.

7. The method of claim 6, wherein:
carbonizing the combined stream of carbonaceous material comprises performing a primary carbonization process;
converting the combined stream of carbonaceous material into activated carbon comprises performing a primary activation process, the primary activation process comprising converting the mixture into an activated mixture of water and activated carbon; and
the method further comprises:
separating the activated carbon from the activated mixture to create separated carbon;
performing a secondary carbonization process on the separated carbon; and
activating the separated carbon in a secondary activation process.

8. The method of claim 7, further comprising, prior to performing the secondary carbonization process, pelletizing the separated carbon to create pelletized activated carbon, wherein the secondary carbonization process is performed on the pelletized activated carbon.

9. The method of claim 1, wherein at least one of the first carbonaceous material and the second carbonaceous material comprises plastic waste, agricultural residue, food waste, human waste, industrial waste, coal, or any combination thereof.

10. The method of claim 1, further comprising forming the activated carbon into an electrode.

11. The method of claim 10, wherein the electrode comprises an electrode of a plurality of discrete electrodes and the method further comprises:
forming the activated carbon into the plurality of discrete electrodes;
forming a plurality of cells of an energy storage system, each cell of the plurality of cells comprising an electrode of the plurality of discrete electrodes; and
electrically connecting the plurality of cells in a series connection.

12. A grid-scale energy storage system comprising:
a supercapacitor comprising a cell, the cell comprising:
a first electrode made of activated carbon;
a second electrode made of activated carbon;
a separator disposed between the first electrode and the second electrode; and
an electrolyte solution.

13. The system of claim 12, wherein the activated carbon comprises carbon activated via the following process:
combining a first stream of a first carbonaceous material and a second stream of a second carbonaceous material into a combined stream of carbonaceous material, wherein a parameter of the first carbonaceous material has a first value and the parameter of the second carbonaceous material has a second value that is different than the first value;
removing only a portion of an impurity, a contaminant, or a combination of the impurity and the contaminant from the combined stream of carbonaceous material;
carbonizing the combined stream of carbonaceous material by exposing the combined stream of carbonaceous material to energy in the form at least one of heat, electricity, microwave radiation, or light; and
converting the combined stream of carbonaceous material into activated carbon.

14. The system of claim 12, wherein the supercapacitor is configured to store energy at a rate of greater than or equal to 1 kilowatt (kW) and the electrolyte solution comprises an aqueous electrolyte solution.

15. A system for processing carbonaceous material, comprising:
a combination unit configured to combine a first stream of a first carbonaceous material and a second stream of a second carbonaceous material into a combined stream of carbonaceous material, wherein a parameter of the first carbonaceous material has a first value and the parameter of the second carbonaceous material has a second value that is different than the first value;
a purification unit configured to remove only a portion of an impurity, a contaminant, or a combination of the impurity and the contaminant from the combined stream of carbonaceous material;
an energy emitter configured to carbonize the combined stream of carbonaceous material by exposing the combined stream of carbonaceous material to energy in the form at least one of: heat, electricity, microwave radiation, or light; and
an activation unit configured to convert the combined stream of carbonaceous material into activated carbon.

16. The system of claim 15, further comprising:
a container, the container comprising an inlet and an outlet; and
a pump configured to move the combined stream of carbonaceous material into the container via the inlet, through the container, and out of the outlet,
wherein:
the energy emitter is located to carbonize the combined stream of carbonaceous material while the combined stream of carbonaceous material is within the container; and
the activation unit is located to convert the combined stream of carbonaceous material into the activated carbon while the combined stream of carbonaceous material is within the container.

17. The system of claim 15, further comprising:
a first conveyor belt;
a second conveyor belt located adjacent to the first conveyor belt;
a first plate interposed between the first conveyor belt and the second conveyor belt; and
a second plate interposed between the first plate and the second conveyor belt.

18. The system of claim 17, wherein:
the first conveyor belt and the second conveyor belt are configured to, when the combined stream of carbonaceous material is received between the first plate and the second plate, move the first plate, the second plate, and the combined stream of carbonaceous material in a direction;
the energy emitter is located to carbonize the carbonaceous material while the combined stream of carbonaceous material is moved in the direction; and
the activation unit is located to convert the combined stream of carbonaceous material into the activated carbon while the combined stream of carbonaceous material is moved in the direction.

19. The system of claim 15, further comprising a press, the press comprising a plurality of plates and configured to receive the combined stream of carbonaceous material between at least two plates of the plurality of plates and apply pressure to the combined stream of carbonaceous material while the carbonaceous material is being carbonized by the energy emitter.

20. The system of claim 15, further comprising a renewable energy source configured to supply the energy to the energy emitter.
